(19) United States
(12) Patent Application Publication
(10) Pub. No.: US 2017/0111833 A1
(43) Pub. Date: Apr. 20, 2017

(54) WIRELESS BASE STATION, WIRELESS COMMUNICATION SYSTEM, WIRELESS COMMUNICATION METHOD AND PROGRAM

(71) Applicant: NEC Corporation, Minato-ku, Tokyo (JP)

(72) Inventor: Takahiro TSUTSUI, Tokyo (JP)

(73) Assignee: NEC Corporation, Minato-ku, Tokyo (JP)

(21) Appl. No.: 15/316,941

(22) PCT Filed: Feb. 17, 2015
(86) PCT No.: PCT/JP2015/054279

§ 371 Date: Dec. 7, 2016

(30) Foreign Application Priority Data
Jun. 18, 2014 (JP) 2014-125216

(51) Int. Cl. H04W 36/04; H04W 36/00; H04W 36/26

(52) U.S. Cl. CPC H04W 36/04; H04W 36/26; H04W 36/0083

(57) ABSTRACT

A wireless base station (15) includes a wireless communication unit that forms a first cell and a control unit configured to make an inquiry, to a wireless base station that forms second cells (cells A to E, G and H) different from the first cell (cell F), whether to allow deactivation of the first cell and determine whether to deactivate the first cell based on a response to such inquiry.

### TECHNICAL FIELD

The present invention relates to a wireless base station, a wireless communication system, a wireless communication method and a program.

### BACKGROUND ART

Recent interest has focused on a technology called HetNet (Heterogeneous Network) as a measure against a rapid increase in wireless network traffic. HetNet is a technology for allowing cells with different radii and schemes to be mixed in the same area in the same system. A wireless communication system to which the HetNet technology is applied has an overlay structure formed by overlaying small cells, such as a microcell, a picocell and a femtocell with a smaller cell radius than a macrocell, in a macrocell with a large cell radius. This technology enables communication capacity in a specific area to increase by overlaying the small cells with a microcell to form the small cells, mainly for specific areas, such as areas with high demand for traffic.

However, traffic of a wireless communication system changes according to the number of wireless terminals that exist in each cell and a size of data transmitted or received by the wireless terminals. Therefore, even if the overlay structure is introduced in an area that often has high demand for traffic, enough throughput may be able to be provided by only a macrocell without small cells due to a decrease in traffic. In this case, power for working small cells is wasted.

As a technology for reducing power consumption in a wireless communication system, there is an energy saving technology of deactivating a cell in response to a load state of each cell. For example, PTL 1 discloses a wireless communication system which employs an energy saving technology. This wireless communication system includes a first wireless device of forming a first cell and a second wireless device of forming a second cell that at least partially overlaps the first cell. When the number of wireless terminals connecting with the first wireless device becomes less than a predetermined number, the first wireless device confirms that the connecting wireless terminals that have been connected with the first wireless device can be connected to the second wireless device and then deactivates the first cell to reduce the power consumption. Specifically, the first wireless device has the connecting wireless terminals measure signal levels of signals received from the second wireless device and determines that the connecting wireless terminals can be connected to the second wireless device if these signal levels exceed a predetermined level. This can prevent the connecting wireless terminals from failing to communicate after the deactivation of the first cell.

### CITATION LIST

### Patent Literature

PTL 1: Japanese Unexamined Patent Application Publication No. 2012-005002

### SUMMARY OF INVENTION

However, in a wireless communication system described in PTL 1, after the first cell is deactivated, the second wireless device requests activation from the first wireless device and the first cell may be activated again. In this case, there has been a problem that a ping pong phenomenon of repeating deactivation and activation of the first cell may occur.

Specifically, when the first wireless device is deactivated, the second wireless device can request activation from the first wireless device based on a predetermined criterion. At this point, the criterion for the second wireless device to determine whether to request activation of the first wireless device is independently set from the criterion for the first wireless device to determine whether to deactivate the first wireless device. For example, when wireless devices of a plurality of vendors are mixed in a wireless communication system, a parameter, its threshold and the like used as criteria for each wireless device to determine whether to request activation are highly different from each other because they are independently set. Thus, even if the first wireless device determines to deactivate the first wireless device, the second wireless device may determine to activate the first wireless device. In this case, the first cell frequently repeats deactivation and activation to cause a ping pong phenomenon.

A ping pong phenomenon causes a service disconnection when a cell is in a state of deactivation or in a transition period between deactivation and activation states. Therefore, for example, if there is a correspondent node whose load balancing with this cell is requested, timing for the load balancing may be delayed to lower communication quality.

One of the objectives of the present invention is to provide a wireless base station, a wireless communication system, a wireless communication method and a program that can prevent a ping pong phenomenon of a cell frequently repeating deactivation and activation.

A wireless base station according to one aspect of the present invention has a wireless communication unit of forming a first cell and a control unit for making an inquiry, whether to allow deactivation of the first cell, to a wireless base station of forming a second cell that is different from the first cell and determining whether to deactivate the first cell based on a response to the inquiry.

Also, a wireless communication system according to one aspect of the present invention includes a first wireless base station of forming a first cell and a second wireless base station of forming a second cell that is different from the first cell, wherein the first wireless base station makes an inquiry to the second wireless base station whether to allow deactivation of the first cell and determines whether to deactivate the first cell based on a response to the inquiry, and the second wireless base station determines whether to allow the deactivation of the first cell in response to the inquiry from the first wireless base station and returns the response indicating the determination result to the first wireless base station.

Also, according to a wireless communication method of one aspect of the present invention, a first cell is formed, an inquiry is made, to a wireless base station of forming a second cell that is different from the first cell, whether to allow deactivation of the first cell , and the determination is made as to whether the first cell is deactivated based on a response to the inquiry.

Also, a program according to one aspect of the present invention makes a computer function as a wireless communication unit of forming a first cell and a control unit for making an inquiry, to a wireless base station forming a second cell that is different from the first cell, whether to allow deactivation of the first cell and determining whether to deactivate the first cell based on a response to the inquiry.

### BRIEF DESCRIPTION OF DRAWINGS

FIG. 1 is a diagram showing a node structure of a wireless communication system 1 according to one exemplary embodiment of the present invention;

FIG. 2 is a diagram showing a coverage structure of a wireless communication system 1;

FIG. 3 is a block diagram showing a structure of eNB 15;

FIG. 4 is a sequence diagram for illustrating an operation of the wireless communication system 1;

FIG. 5 is a diagram showing one example of indication information transmitted by eNB 15 to adjacent wireless base stations and response information received by eNB 15 from each adjacent wireless base station in response to such transmitted information; and

FIG. 6 is a flowchart for illustrating a more detailed operation of step S107 in FIG. 4.

### DESCRIPTION OF EMBODIMENTS

The following describes the exemplary embodiments of the present invention with reference to the accompanying drawings. It is noted that overlapped explanations may be omitted by assigning the same reference numerals to components having the same functions in this description and the drawings.

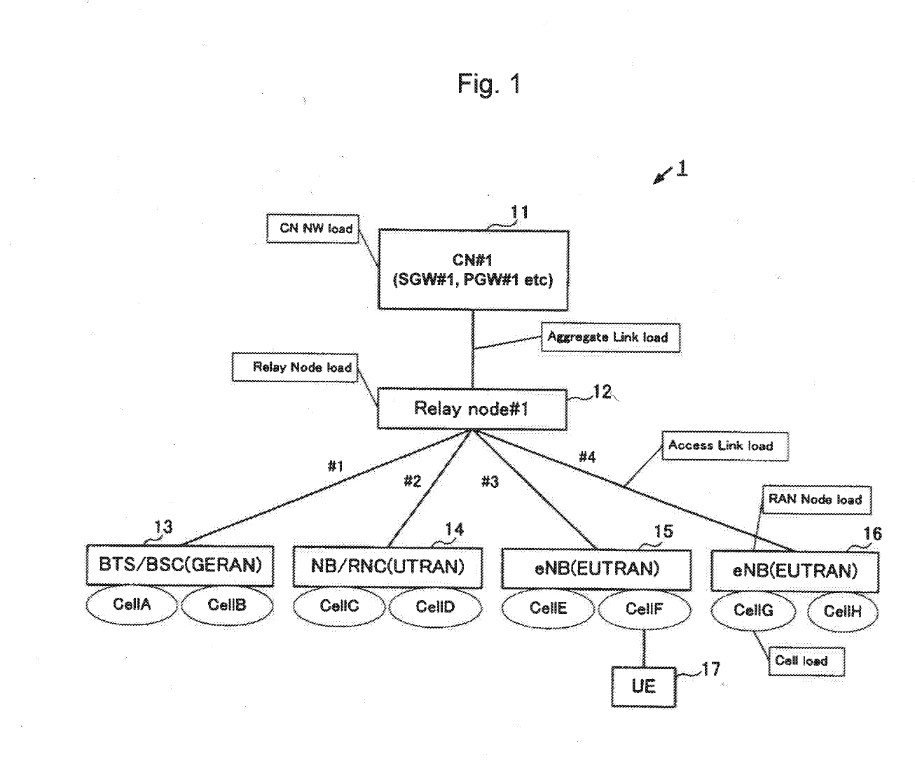

FIG. 1 is a diagram showing a node structure of a wireless communication system 1 according to one exemplary embodiment of the present invention. The wireless communication system 1 has CN (Core Network) 11, a relay node 12 connected with CN 11 and various base stations connected with the relay node 12.

The base stations include BTS (Base Transceiver Station)/BSC (Base Station Controller) 13, NB (NodeB)/RNC (Radio Network Controller) 14, and eNB (eNodeB) 15 and eNB 16.

CN 11 is a communication line used as a center of communication. CN 11 transfers a message between RANs. Specifically, CN 11 transfers a message between eNB 15 (EUTRAN) and eNB 16 (EUTRAN), and between eNB 15 (or eNB 16) (EUTRAN) and RNC/NB 14 (UTRAN). CN 11 also transfers a message between eNB 15 (or eNB 16) (EUTRAN) and BTS/BSC 13 (GERAN). The relay node 12 routes traffic between CN 11 and RAN.

Each base station forms a cell and UE (User Equipment) is connected thereto. Specifically, BTS/BSC 13 forms cells A and B. NB/RNC 14 forms cells C and D. The eNB 15 forms cells E and F. The eNB 16 forms cells G and H.

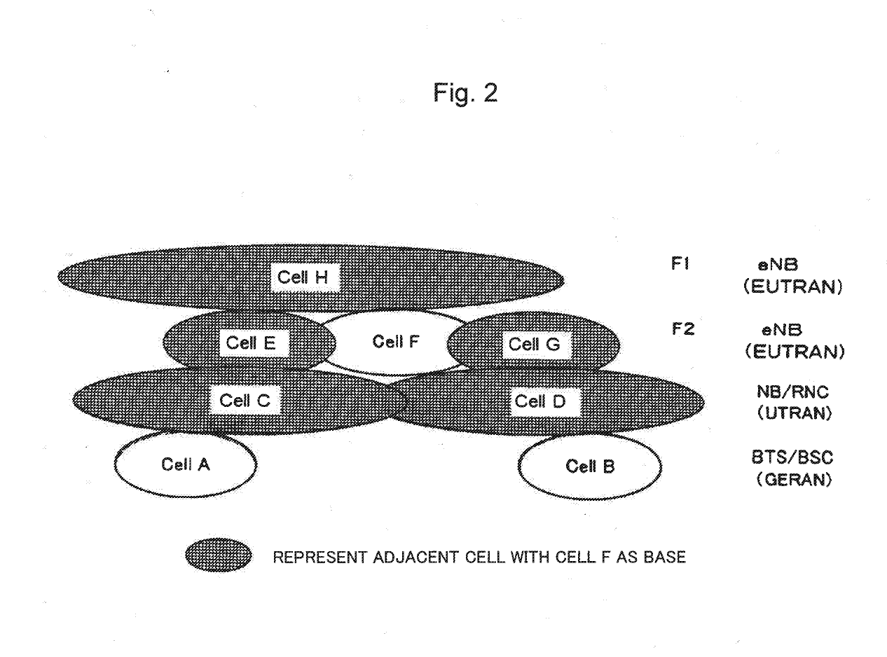

FIG. 2 is a diagram showing a coverage structure example of the wireless communication system 1. A coverage structure of cells formed by respective base stations is an overlay structure as shown in FIG. 2. In this structure, considering the cell F as a basing point, adjacent cells of the cell F are cells C, D, E, G and H. Of these cells, the cell H is an overlay cell that contains the cell F.

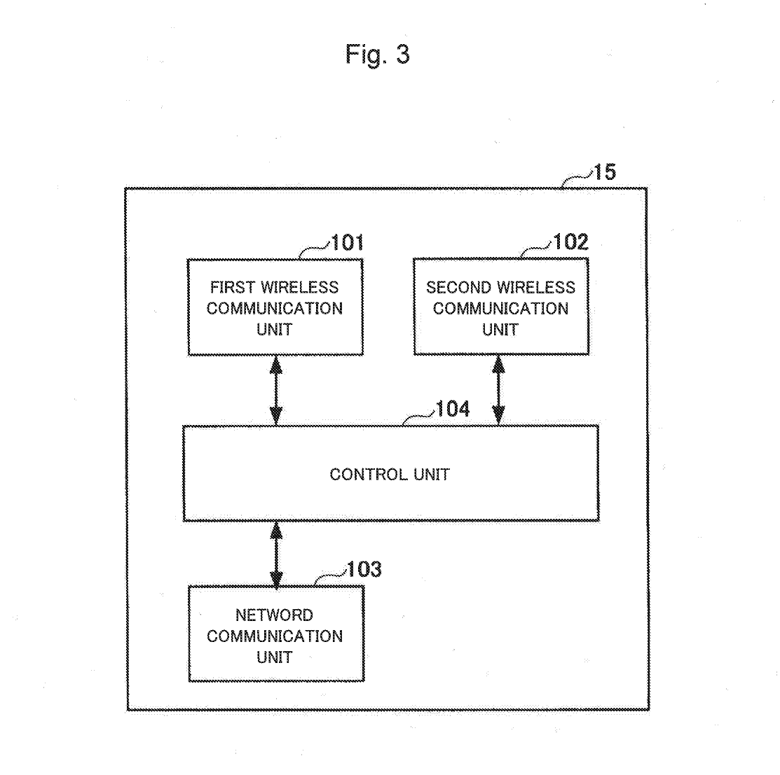

FIG. 3 is a block diagram showing a structure of eNB 15. FIG. 3 shows a structure of eNB 15 as one example of the wireless base stations and other wireless base stations: BTS/BSC 13, NB/RNC 14 and eNB 16, also have a similar structure. The eNB 15 has a first wireless communication unit 101, a second wireless communication unit 102, a network communication unit 103 and a control unit 104.

The first wireless communication unit 101 forms the cell E and communicates with UE that exists in the cell E. The second wireless communication unit 102 forms the cell F and communicates with UE that exists in the cell F. The network communication unit 103 conducts the inter-base station communication with other wireless base stations: BTS/BSC 13, NB/RNC 14, eNB 16 and the like.

The control unit 104 controls an operation of eNB 15 using the first wireless communication unit 101, the second wireless communication unit 102 and the network communication unit 103. Specifically, the control unit 104 determines whether to deactivate each of the first wireless communication unit 101 and the second wireless communication unit 102 based on cell load information. The deactivation means changing the first wireless communication unit 101 or the second wireless communication unit 102 from an activated state to a deactivated state. Power provided to the first wireless communication unit 101 or the second wireless communication unit 102 in the deactivated state may be smaller than power provided in the activated state, for example, may be zero. In this case, the activated state is a state where the first wireless communication unit 101 or the second wireless communication unit 102 can communicate and alternately the deactivated state is a state where the first wireless communication unit 101 or the second wireless communication unit 102 may not communicate.

When a load shown by the cell load information becomes a predetermined threshold or less, the control unit 104 starts determining whether to deactivate a cell whose load becomes the threshold or less. In the following description, a cell whose load shown by the cell load information becomes a predetermined threshold or less to be the target of the deactivation is referred to as the first cell and the other cell other than the first cell is referred to as the second cells. If the wireless communication system 1 includes three or more cells, a plurality of second cells are present.

The control unit 104 causes a connecting terminal of a wireless terminal connecting with the first cell to measure signal strength of a signal received from the wireless base station that forms a cell other than the first cell and causes the terminal to notify the measurement result using the second wireless communication unit 102. The control unit 104 makes an inquiry, to a wireless base station that forms a second cell, whether the deactivation of the first cell is allowed using the network communication unit 103. When the control unit 104 receives a response to the inquiry, the control unit 104 determines whether to deactivate the first cell based on the response.

The control unit 104 also notifies the wireless base station that forms the second cell of a deactivation condition for deactivating the first cell as well as this inquiry and causes the wireless base station to determine whether to allow the deactivation of the first cell based on the deactivation condition. For example, the control unit 104 selects a destination of handover of the second cells for handing over a connecting terminal based on a measurement result of the signal strength and gives notice of the number of connecting terminals handed over to each second cell. Wireless base stations that form the second cells can determine whether to allow the deactivation of the first cell based on whether the second cells can accept the notified number of handed-over connecting terminals. It is noted that criteria for determining whether the wireless base stations that form the second cells allow the deactivation of the first cell may vary depending on each wireless base station. It is desirable that a parameter or a threshold included in the criteria that each wireless base station determines whether to allow the deactivation of the first cell is the same as a parameter or a threshold included in criteria that each wireless base station determines whether to request the activation of the first cell. Use of these criteria can more reliably prevent a ping pong phenomenon of frequently repeating deactivation and activation.

The control unit 104 also gives notice of a request for handing over the connecting terminals to a second cell as the deactivation condition if the second cell is an overlay cell that contains the first cell. Limitation of a destination of the connecting terminal handover to an overlay cell can improve communication quality of the connecting terminals after the handover. The control unit 104 can give notice of conditions by transmitting indication information showing these deactivation conditions to each wireless base station.

The control unit 104 determines whether to deactivate the first cell based on the responses showing whether each wireless base station that forms a second cell allows the deactivation of the first cell. For example, if all the responses show allowance of the first cell deactivation, the control unit 104 can deactivate the first cell. Also, if there is a response that the deactivation of the first cell is not allowed, the control unit 104 makes an inquiry into an allowable condition that each wireless base station can allow the deactivation of the first cell and adjusts a condition for deactivating the first cell based on this allowable condition. For example, the control unit 104, as the allowable condition, can make an inquiry into the number of connecting terminals whose handover can be accepted by each second cell. In this case, the control unit 104 can adjust handover destinations of the connecting terminals based on such number.

In the case of limiting the handover destinations of the connecting terminals to an overlay cell, for example, if the first cell is the cell F and it is determined that all the connecting terminals can be handed over to the cell H that is an overlay cell of the cell F, the cell F will be deactivated.

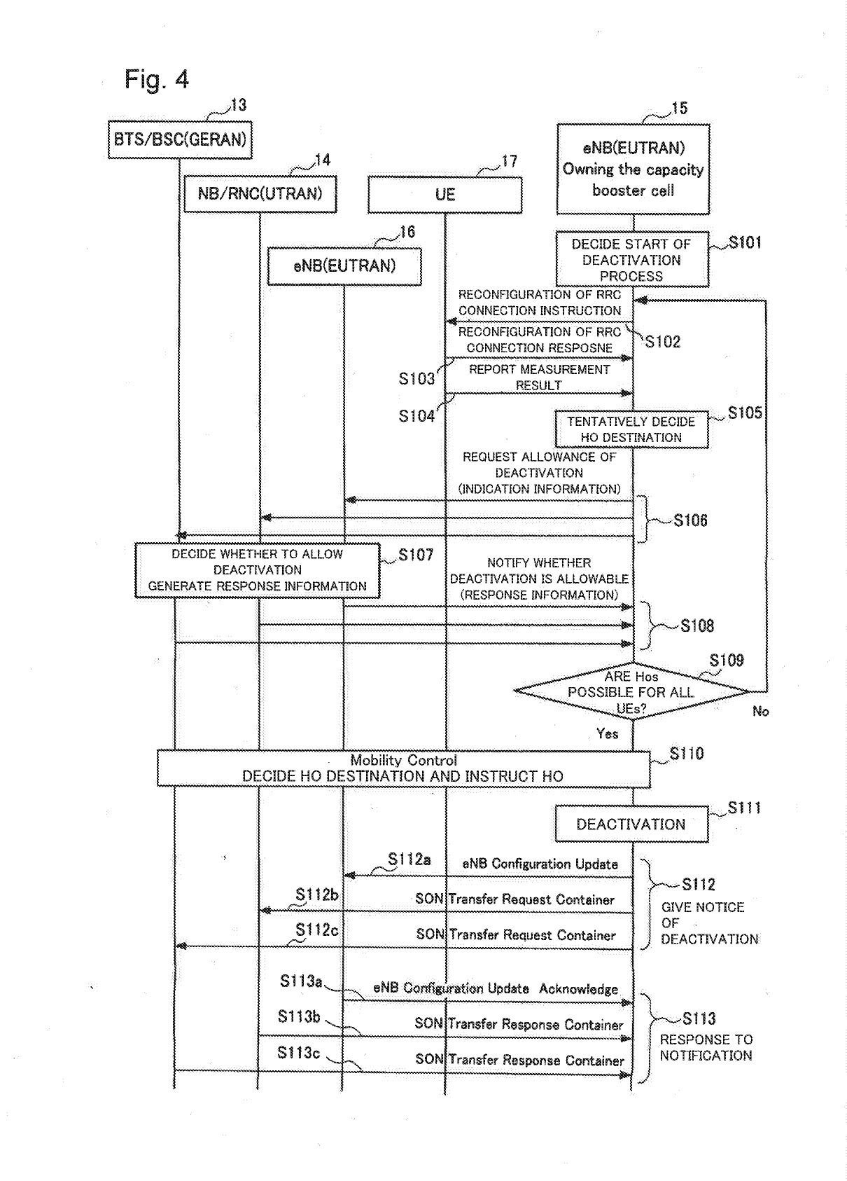

The following describes an operation of the wireless communication system 1 using an example that the first cell is the cell F. In this case, eNB 5 is a first wireless base station of forming the first cell and BTS/BSC 13, NB/RNC 14 and eNB 16 are second wireless base stations of forming the second cells. Hereinafter, BTS/BSC 13, NB/RNC 14 and eNB 16 may be collectively referred to as second wireless base stations as necessary. FIG. 4 is a sequence diagram for illustrating an operation of the wireless communication system 1.

Firstly, eNB 15 decides a start of a deactivation process. Specifically, eNB 15 determines whether to deactivate each of cells E and F based on their respective cell load information and decides to start the deactivation process if it is determined to deactivate any one of the respective cells (step S101).

When eNB 15 decides to start the deactivation process for the cell F, eNB 15 transmits an instruction of performing reconfiguration of RRC connection to UE 17 of a connecting terminal that is connected with the second wireless communication unit 102. Specifically, eNB 15 transmits an instruction of measuring communication strength with adjacent cells to UE 17 as an instruction for performing the reconfiguration of the RRC connection (step S102). UE 17 receives this instruction and returns a response of the receipt to eNB 15 (step S103). UE 17 measures the communication strength with the adjacent cells according to the instruction from eNB 15 and notifies eNB 15 of the measurement result (step S104).

eNB 15 receives the measurement result from UE 17 and decides a destination cell for handover of UE 17 tentatively based on such measurement result. At this point, eNB 15 generates indication information, which is a condition for the deactivation of the cell F, for determining whether BTS/BSC 13, NB/RNC 14 and eNB 16 allow the deactivation of the cell F (step S105).

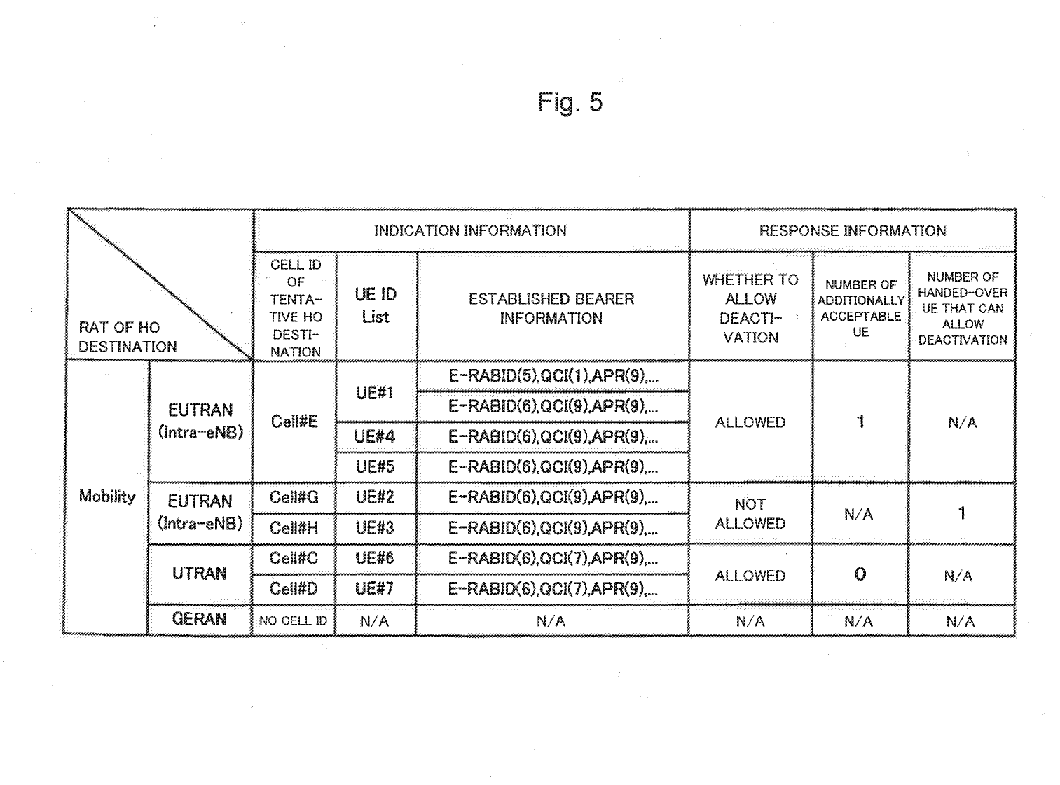

FIG. 5 is a diagram showing one example of indication information transmitted by the eNB 15 to BTS/BSC 13, NB/RNC 14 and eNB 16 and response information received by the eNB 15 from each of BTS/BSC 13, NB/RNC 14 and eNB 16 in response to such indication information. The indication information includes a list of UE handed over to each cell and established bearer information of each UE. The established bearer information can include, for example, information notified to a handover destination cell at the time of handover (information defined in X2AP: HANDOVER REQUEST or S1AP: HANDOVER REQUEST). The indication information can also include a flag showing whether to hand over a connecting terminal connected with a cell to be deactivated to an overlay cell. The connecting terminal is handed over to the overlay cell if this flag is on and the connecting terminal is handed over to not only the overlay cell but also neighboring cells if the flag is not on.

Returning to the description of the operation in FIG. 4, eNB 15 transmits a message for a request to allow the deactivation to each of BTS/BSC 13, NB/RNC 14 and eNB 16. This message includes the indication information generated by eNB 15 in step S105. At this point, in the case of requesting handover only to the overlay cell, eNB 15 notifies BTS/BSC 13, NB/RNC 14 and eNB 16 of a flag showing the request of the handover only to the overlay cell (step S106).

BTS/BSC 13, NB/RNC 14 and eNB 16 decide whether to accept the deactivation of the cell F based on the received indication information. Specifically, BTS/BSC 13, NB/RNC 14 and eNB 16 determines whether a load of each second cell is within an allowable range in the case of handing over by UE shown by the indication information to each second cell. BTS/BSC 13, NB/RNC 14 and eNB 16 decide whether to allow the deactivation of the first cell based on their determination results. Also, if the deactivation is allowed, BTS/BSC 13, NB/RNC 14 and eNB 16 calculate the number of UE that can be accepted in addition to the number of handed over UE that are notified by the indication information for each cell formed by BTS/BSC 13, NB/RNC 14 and eNB 16. If the deactivation is not allowed, BTS/BSC 13, NB/RNC 14 and eNB 16 calculate how many UE that can accept the handover is needed to allow the deactivation. As shown in FIG. 5, each of BTS/BSC 13, NB/RNC 14 and eNB 16 generates response information showing allowable conditions that are conditions for being able to allow the deactivation, including whether to allow the deactivation, the number of additionally acceptable UE and the number of accepted UE that can allow the deactivation (step S107).

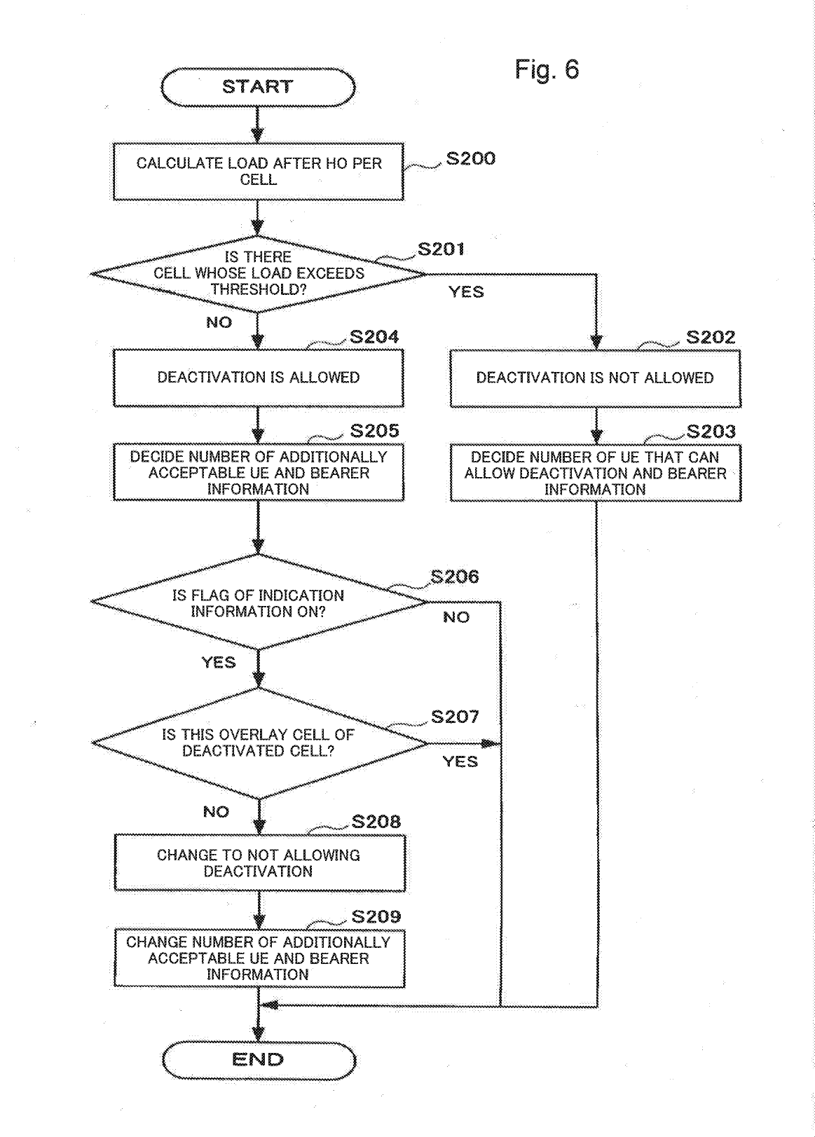

FIG. 6 is a flowchart for illustrating a more detailed operation of step S107. Each operation shown in FIG. 6 is executed by each second wireless base station.

A second wireless base station calculates a load born in the case of handing over each connecting terminal to the destination of handover shown by the received indication information on a cell basis (step S200). The second wireless base station determines whether there is a cell whose load exceeds the threshold (step S201).

If there is a cell whose load exceeds the threshold, the second wireless base station does not allow the deactivation of the first cell (step S202). The second wireless base station decides the number of UE that can allow the deactivation of the first cell and the bearer information (step S203). In this case, the following process is omitted.

If there is no cell whose load exceeds the threshold, the second wireless base station allows the deactivation of the first cell (step S204). The second wireless base station decides the number of UE that can be additionally accepted and the bearer information in addition to UE shown by the indication information (step S205).

The second wireless base station subsequently determines whether a flag of the indication information is on (step S206). If the flag is on, the second wireless base station determines whether the second cells formed by such second wireless base station are overlay cells of the first cell to be deactivated (step S207). If the second cells are not the overlay cells, the second wireless base station changes the decision to not allow the deactivation (step S208). The number of UE that can be additionally accepted and the bearer information are also changed to “Nothing” (step S209).

If a flag is not on in step S206, steps S207 to S209 are omitted. Also, if it is determined that the second cell is the overlay cell in step S207, steps S208 and S209 are omitted.

As described above, each second wireless base station determines whether to allow the deactivation of a specified cell by executing the operation shown in FIG. 6.

Returning to the description of FIG. 4, each of BTS/BSC 13, NB/RNC 14 and eNB 16 responds to eNB 15 whether to allow the deactivation by transmitting the response information generated in step S107 to eNB 15 (step S108).

The eNB 15 receives the response information received from each of BTS/BSC 13, NB/RNC 14 and eNB 16 and determines whether all of UE 17 can be handed over based on the received response information. Specifically, eNB 15 determines that all of UE 17 can be handed over if the sum of the number of wireless terminals that can be handed over to the second cells of overlay cells is the number of connecting terminals or more (step S109).

If all UE cannot be handed over, eNB 15 returns to step S102 and repeats steps S102 to S108 again. At this point, eNB 15 changes the destination of handover decided in step S105 based on the response information received in step S108. Specifically, based on the response information, the handover destination cells are adjusted to increase the number of UE 17 handed over to a cell whose number of UE that can be additionally accepted is one or more. If all UE can be handed over, eNB 15 decides the destinations of handover and instructs each connecting terminal on handover (step S110). The eNB 15 deactivates the first cell (step S111).

When the deactivation of the first cell is completed, eNB 15 notifies each of BTS/BSC 13, NB/RNC 14 and eNB 16 of the completion of the deactivation (step S112). Each of BTS/BSC 13, NB/RNC 14 and eNB 16 that receives this notification responds to the notification (step S113).

Specifically, eNB 16 receives a notification that the deactivation is completed from eNB 15 with “eNB Configuration Update” (step S112a) and responds to eNB 15 with “eNB Configuration Update Acknowledge” (step S113a). Also, NB/RNC 14 receives a notification that the deactivation is completed from eNB 15 with “SON Transfer Request Container” (step S112b) and responds to the eNB 15 with “SON Transfer Response Container” (step S113b). In addition, BTS/BSC 13, similarly to NB/RNC 14, receives a notification that the deactivation is completed from eNB 15 with “SON Transfer Request Container” (step S112c) and responds to eNB 15 with “SON Transfer Response Container” (step S113c).

As described above, according to one exemplary embodiment of the present invention, eNB 15 has the second wireless communication unit 102 that forms the cell F and the control unit 104. The control unit 104 makes an inquiry to wireless base stations (BTS/BSC 13, NB/RNC 14 and eNB 16) that forms the second cells (cells A to E, G and H) that are different from the cell F whether to allow deactivation of the cell F. The control unit 104 determines whether to deactivate the cell F based on responses to such inquiry. With this structure, it is determined whether the first cell is deactivated based on whether the wireless base stations that form the cells A to E, G and H different from the cell F which is the target of the deactivation allow the deactivation of the first cell. This can reduce a possibility that the wireless base stations that form the second cells request the activation of the cell F and prevent a ping pong phenomenon that the cells frequently repeat deactivation and activation, after the deactivation of the first cell.

Also, according to the above exemplary embodiments, the control unit 104 notifies each of BTS/BSC 13, NB/RNC 14 and eNB 16 that forms the cells A to E, G and H of a deactivation condition for deactivating the cell F and causes BTS/BSC 13, NB/RNC 14 and eNB 16 to determine whether to allow the deactivation of the cell F based on such deactivation condition. This structure enables BTS/BSC 13, NB/RNC 14 and eNB 16 to determine more correctly whether this is a situation that the deactivation may be allowed. Thus, a possibility that the wireless base stations that form the second cells request the activation of the first cell can be reduced more reliably and a ping pong phenomenon can be more reliably prevented after the deactivation of the first cell.

Also, according to the above exemplary embodiments, the control unit 104 gives notice of the number of connecting terminals handed over to each of the cells A to E, G and H out of connecting terminals that are wireless terminals connecting with the second wireless communication unit 102 as the deactivation condition. With this structure, BTS/BSC 13, NB/RNC 14 and eNB 16 can determine whether to allow the deactivation of the cell F based on a load of each cell in the case of accepting the handover of the notified number of connecting terminals. Thus, a possibility that the wireless base stations that form the second cells request the activation of the first cell can be reduced more reliably and a ping pong phenomenon can be more reliably prevented after the deactivation of the first cell.

Also, according to the above exemplary embodiments, the control unit 104 gives notice of a request for handing over the connecting terminals to the cells A to E, G and H as the deactivation condition if the cells A to E, G and H are overlay cells that contain the cell F. With this structure, it is determined whether each second cell allows the deactivation of the first cell based on whether the second cells are overlay cells of the first cell. Because this can limit the handover destinations of the connecting terminals to overlay cells, a possibility that the connecting terminals are located at edges of cells after the handover can be reduced and communication quality after the handover of the connecting terminals can be stabilized.

In addition, according to the above exemplary embodiments, there are a plurality of wireless base stations that form the second cells. When there is a wireless base station that does not allow the deactivation of the cell F, the control unit 104 makes an inquiry to the wireless base stations that form the second cells: BTS/BSC 13, NB/RNC 14 and eNB 16, an allowable condition that is a condition for allowing the deactivation of the first cell. The control unit 104 adjusts the deactivation condition based on the allowable condition. This adjusts the deactivation condition based on a condition that each wireless base station can allow the deactivation even if there is a wireless base station that does not allow the deactivation of the first cell. Thus, a possibility that the deactivation of the first cell is allowed can be increased and, while preventing a ping pong phenomenon, a possibility of reducing power consumption can be enhanced.

Also, according to the above exemplary embodiments, the control unit 104 makes an inquiry, to the wireless base stations that form the second cells, the number of connecting terminals that can be handed over as the allowable condition. This structure can adjust the deactivation condition based on the number of the connecting terminals that can be handed over to each second cell. Therefore, a change in the handover destination of each connecting terminal from the wireless base stations that cannot accept handover to the wireless base stations that can accept handover in the deactivation condition can enhance a possibility that each wireless base station can allow the deactivation. Thus, a possibility that the deactivation of the first cell is allowed can be enhanced, and while with preventing a ping pong phenomenon, a possibility of reducing power consumption can be enhanced.

In addition, according to the above exemplary embodiments, there are a plurality of wireless base stations that form the second cells. The control unit 104 makes an inquiry to a plurality of wireless base stations, BTS/BSC 13, NB/RNC 14 and eNB 16, respectively. The control unit 104 determines whether to deactivate the cell F based on a plurality of responses showing determination results obtained by each wireless base station determining whether to allow the deactivation of the cell F by respective criteria. Accordingly, if vendors of the wireless base stations, BTS/BSC 13, NB/RNC 14 and eNB 16, are different from one another, each wireless base stations can determine whether to allow the deactivation by respective criteria. Thus, a possibility that the wireless base stations that form the second cells request the activation of the first cell can be reduced more reliably and a ping pong phenomenon can be more reliably prevented after the deactivation of the first cell.

As one example of effects of the present invention, a ping pong phenomenon that a cell frequently repeats deactivation and activation can be prevented.

The invention of the present application is described above with reference to the exemplary embodiments, but the invention of the present application is not limited to the above exemplary embodiments. Various changes that those skilled in the art could understand can be made to the structure or details of the invention of the present application within the scope of the invention of the present application.

For example, the structures and operations of the wireless communication system 1 and the wireless base stations are mainly described in the above exemplary embodiments, but the technology of the present invention can be implemented as a method or program for realizing operations of the wireless communication system 1 and the wireless base stations. The program may be stored in a computer-readable recording medium.

Also, in the above exemplary embodiments, a cell is not deactivated until all connecting terminals can be handed over to an overlay cell, but the present invention is not limited to such example. Even if all the connecting terminals cannot be handed over to the overlay cell, the cell may be deactivated in the case of being able to handing over the connecting terminals to adjacent cells other than the overlay cell after preferentially handing over the connecting terminals to the overlay cell.

In addition, the communication scheme or structure used in the wireless communication system 1 according to the above exemplary embodiments is one example and the technology of the present invention can be applied in systems with any structures. Also, depending on each communication scheme or structure, a specific process for realizing a technology concept of the present invention can be changed. Furthermore, this application claims priority based on Japan Patent Application No. 2014-125216, filed on Jun. 18, 2014, the contents of which are incorporated herein in their entirely.

### REFERENCE SIGNS LIST

1 Wireless communication system
11 CN
12 Relay node
13 BTS/BSC
14 NB/RNC
15 eNB
16 eNB
17 UE (connecting terminal)
101 First wireless communication unit
102 Second wireless communication unit
103 Network communication unit
104 Control unit

What is claimed is:

1. A wireless base station, comprising:
a wireless communication unit configured to form a first cell; and
a control unit configured to make an inquiry, to a wireless base station that forms a second cell different from the first cell, whether to allow deactivation of the first cell and determine whether to deactivate the first cell based on a response to the inquiry.

2. The wireless base station according to claim 1, wherein the control unit notifies the wireless base station that forms the second cell of a deactivation condition for deactivating the first cell and causes the wireless base station to determine whether to allow the deactivation of the first cell based on the deactivation condition.

3. The wireless base station according to claim 2, wherein the control unit gives notice of the number of connecting terminals handed over to the second cell out of connecting terminals that are wireless terminals connecting with the wireless communication unit as the deactivation condition.

4. The wireless base station according to claim 2, claim 2 or 3, wherein the control unit gives notice of a request for handing over the connecting terminals to the second cell as the deactivation condition if the second cell is an overlay cell that contains the first cell.

5. The wireless base station according to claim 2, wherein
there are a plurality of wireless base stations that form the second cell; and
the control unit makes an inquiry, to the wireless base stations that form the second cell, an allowable condition that is a condition for being able to allow the deactivation of the first cell and adjusts the deactivation condition based on the allowable condition if there is a wireless base station that does not allow the deactivation of the first cell.

6. The wireless base station according to claim 5, wherein the control unit makes an inquiry, to the wireless base station that forms the second cell, the number of connecting terminals that can be handed over as the allowable condition.

7. The wireless base station according to claim 1, wherein there are a plurality of wireless base stations that form the second cell; and
the control unit makes an inquiry to each of the plurality of wireless base stations and determines whether to deactivate the first cell based on a plurality of the responses showing determination results obtained by respective wireless base stations determining whether to allow the deactivation of the first cell by respective criteria.

8. A wireless communication system, comprising:
a first wireless base station that forms a first cell; and
a second wireless base station that forms a second cell different from the first cell,
wherein the first wireless base station makes an inquiry, to the second wireless base station, whether to allow deactivation of the first cell and determines whether to deactivate the first cell based on a response to the inquiry; and
the second wireless base station determines whether to allow the deactivation of the first cell in response to the inquiry from the first wireless base station and returns the response showing a determination result to the first wireless base station.

9. A wireless communication method comprising:
forming a first cell;
making an inquiry, to a wireless base station that forms a second cell different from the first cell, whether to allow deactivation of the first cell; and
determining whether to deactivate the first cell based on a response to such inquiry.

10. A non-transitory computer-readable recording medium recording a program for making a computer function as
a wireless communication unit configured to form a first cell; and
a control unit configured to make an inquiry to a wireless base station that forms a second cell different from the first cell, whether to allow deactivation of the first cell and determine whether to deactivate the first cell based on a response to such inquiry.
